(19) United States
(12) Patent Application Publication
(10) Pub. No.: US 2020/0311032 A1
(43) Pub. Date: Oct. 1, 2020

(54) System and Method for Content Development Management

(71) Applicant: Lincoln Learning Solutions, Inc., Rochester, PA (US)

(72) Inventors: David Whitehead, Greensburg, PA (US); Brittany Janectic, Monaca, PA (US); James Joplin, Valencia, PA (US); Zachary La Lond, Tulsa, OK (US); Erik Meuser, Forest Hills, PA (US); Robert Braund, Coraopolis, PA (US); Daryl E. Care, Aliquippa, PA (US)

(21) Appl. No.: 16/830,778

(22) Filed: Mar. 26, 2020

Related U.S. Application Data
(60) Provisional application No. 62/823,692, filed on Mar. 26, 2019.

(51) Int. Cl. G06F 16/176; G09B 5/10

(52) U.S. Cl. CPC G06F 16/1774; G09B 5/10

(57) ABSTRACT

Provided is a system and method for content development management. The content development management system may distribute a content development platform to a plurality of different entities, each entity of the plurality of entities including a plurality of users, receive, from a first user associated with a first entity of the plurality of entities, a first modification to first content, store the first modification to the first content in a database in association with the first entity, such that other entities of the plurality of entities cannot access the first modification; and allow access to the first modification to the first content from authorized users of the first entity.

### CROSS-REFERENCE TO RELATED APPLICATION

This application claims the benefit of U.S. Provisional Application No. 62/823,692 filed on Mar. 26, 2019, the disclosure of which is incorporated herein by reference.

### BACKGROUND

### 1. Field

This disclosure relates generally to educational content development management systems and methods.

### 2. Technical Considerations

Current educational content development management systems present severe technical limitations that prevent and restrict fast and efficient access to content and management of changes and modifications.

### SUMMARY

According to non-limiting embodiments or aspects, provided is a content development management system, comprising at least one server computer in communication with a plurality of user computers over a network environment, the at least one server computer including at least one processor programmed or configured to: distribute a content development platform to a plurality of different entities, each entity of the plurality of entities comprising a plurality of users; receive, from a first user associated with a first entity of the plurality of entities, a first modification to first content; store the first modification to the first content in a database in association with the first entity, such that other entities of the plurality of entities cannot access the first modification; and allow access to the first modification to the first content from authorized users of the first entity.

In non-limiting embodiments or aspects, the content development platform comprises a plurality of activity templates. In non-limiting embodiments or aspects, the at least one processor is further programmed or configured to: receive, from the first user, a publication request associated with the first modification to the first content; queue the publication request in a publication queue; and in response to an input from an administrative user, publish the first modification to the first content such that the authorized users of the first entity are allowed access. In non-limiting embodiments or aspects, the at least one processor is further programmed or configured to: in response to receiving a check-out request from the first user for the first content, lock the first content, allowing only the first user of the plurality of users to modify the first content; and in response to receiving a check-in request from the first user for the first content, store the first content in a database in association with the first content and allow access to the first content from authorized users of the first entity.

In non-limiting embodiments or aspects, the at least one processor is further programmed or configured to: receive, from the first user associated with the first entity of the plurality of entities, a second modification to the first content; store the second modification to the first content in a database in association with the first entity; and receive, from the first user associated with the first entity of the plurality of entities, a request to restore the first modification to the first content, replacing the second modification to the first content with the first modification to the first content. In non-limiting embodiments or aspects, the at least one processor is further programmed or configured to: store an interactive asset in a database in association with the first entity; link the interactive asset to the first content; and display the interactive asset in the first content when accessed by an end-user. In non-limiting embodiments or aspects, the at least one processor is further programmed or configured to: link the interactive asset to a second content; receive a modification to the interactive asset; and display the modification to the interactive asset in both the first content and the second content when accessed by an end-user.

According to non-limiting embodiments or aspects, provided is a computer-implemented method of content development management, comprising: distributing, with at least one processor, a content development platform to a plurality of different entities, each entity of the plurality of entities comprising a plurality of users; receiving, from a first user associated with a first entity of the plurality of entities, a first modification to first content; storing, with the at least one processor, the first modification to the first content in a database in association with the first entity, such that other entities of the plurality of entities cannot access the first modification; and allowing, with the at least one processor, access to the first modification to the first content from authorized users of the first entity.

In non-limiting embodiments or aspects, the content development platform comprises a plurality of activity templates. In non-limiting embodiments or aspects, the method further comprises: receiving, from the first user, a publication request associated with the first modification to the first content; queueing, with the at least one processor, the publication request in a publication queue; and in response to an input from an administrative user, publishing, with the at least one processor, the first modification to the first content such that the authorized users of the first entity are allowed access. In non-limiting embodiments or aspects, the method further comprises: in response to receiving a check-out request from the first user for the first content, locking the first content, allowing only the first user of the plurality of users to modify the first content; and in response to receiving a check-in request from the first user for the first content, storing the first content in a database in association with the first content and allowing access to the first content from authorized users of the first entity.

In non-limiting embodiments or aspects, the method further comprises: receiving, from the first user associated with the first entity of the plurality of entities, a second modification to the first content; storing the second modification to the first content in a database in association with the first entity; and receiving, from the first user associated with the first entity of the plurality of entities, a request to restore the first modification to the first content, replacing the second modification to the first content with the first modification to the first content. In non-limiting embodiments or aspects, the method further comprises: storing, with the at least one processor, an interactive asset in a database in association with the first entity; linking, with the at least one processor, the interactive asset to the first content; and displaying, with the at least one processor, the interactive asset in the first content when accessed by an end-user. In non-limiting embodiments or aspects, the method further comprises: linking, with the at least one processor, the interactive asset to a second content; receiving, with the at least one processor, a modification to the interactive asset; and displaying, with the at least one processor, the modification to the interactive asset in both the first content and the second content when accessed by an end-user.

According to non-limiting embodiments or aspects, provided is a computer program product of content development management, comprising at least one non-transitory computer-readable medium including program instructions that, when executed by at least one processor, cause the at least one processor to: distribute a content development platform to a plurality of different entities, each entity of the plurality of entities comprising a plurality of users; receive, from a first user associated with a first entity of the plurality of entities, a first modification to first content; store the first modification to the first content in a database in association with the first entity, such that other entities of the plurality of entities cannot access the first modification; and allow access to the first modification to the first content from authorized users of the first entity.

In non-limiting embodiments or aspects, the content development platform comprises a plurality of activity templates. In non-limiting embodiments or aspects, the program instructions further cause the at least one processor to: receive, from the first user, a publication request associated with the first modification to the first content; queue the publication request in a publication queue; and in response to an input from an administrative user, publish the first modification to the first content such that the authorized users of the first entity are allowed access. In non-limiting embodiments or aspects, the program instructions further cause the at least one processor to: in response to receiving a check-out request from the first user for the first content, lock the first content, allowing only the first user of the plurality of users to modify the first content; and in response to receiving a check-in request from the first user for the first content, store the first content in a database in association with the first content and allow access to the first content from authorized users of the first entity.

In non-limiting embodiments or aspects, the program instructions further cause the at least one processor to: receive, from the first user associated with the first entity of the plurality of entities, a second modification to the first content; store the second modification to the first content in a database in association with the first entity; and receive, from the first user associated with the first entity of the plurality of entities, a request to restore the first modification to the first content, replacing the second modification to the first content with the first modification to the first content. In non-limiting embodiments or aspects, the program instructions further cause the at least one processor to: store an interactive asset in a database in association with the first entity; link the interactive asset to the first content; display the interactive asset in the first content when accessed by an end-user; link the interactive asset to a second content; receive a modification to the interactive asset; and display the modification to the interactive asset in both the first content and the second content when accessed by an end-user.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise.

### BRIEF DESCRIPTION OF THE DRAWINGS

Additional advantages and details of non-limiting embodiments are explained in greater detail below with reference to the exemplary embodiments that are illustrated in the accompanying schematic figures and appendices, in which:

FIG. 1A is a schematic diagram of a content development management system according to a non-limiting embodiment;

FIG. 1B is a schematic diagram of a content development management system according to a non-limiting embodiment;

FIG. 2 illustrates example components of a device used in connection with non-limiting embodiments;

FIG. 3 illustrates an example GUI display of an align activity template according to a non-limiting embodiment;

FIG. 4 illustrates an example GUI display of a chart activity template according to a non-limiting embodiment;

FIG. 5 illustrates an example GUI display of a crossword activity template according to a non-limiting embodiment;

FIGS. 6A-B illustrate example GUI displays of a “Did You Know” activity template according to non-limiting embodiments;

FIGS. 7A-B illustrate example GUI displays of a drag and drop activity template according to non-limiting embodiments;

FIGS. 8A-D illustrate example GUI displays of a flashcard activity template according to non-limiting embodiments;

FIG. 9 illustrates an example GUI display of a hotspot activity template according to a non-limiting embodiment;

FIGS. 10A-C illustrate example GUI displays of an identity activity template according to non-limiting embodiments;

FIG. 11 illustrates an example GUI display of a jigsaw activity template according to a non-limiting embodiment;

FIG. 12 illustrates an example GUI display of a labeling activity template according to a non-limiting embodiment;

FIG. 13 illustrates an example GUI display of an ordering activity template according to a non-limiting embodiment;

FIG. 14 illustrates an example GUI display of a pairs activity template according to a non-limiting embodiment;

FIG. 15 illustrates an example GUI display of a photo album activity template according to a non-limiting embodiment;

FIGS. 16A-C illustrate example GUI displays of a selection activity template according to non-limiting embodiments;

FIGS. 17A-C illustrate example GUI displays of a sequence activity template according to non-limiting embodiments;

FIG. 18 illustrates an example GUI display of a slideshow activity template according to a non-limiting embodiment;

FIG. 19 illustrates an example GUI display of a timeline activity template according to a non-limiting embodiment;

FIG. 20 illustrates an example GUI display of a word search activity template according to a non-limiting embodiment;

FIG. 21 illustrates an example GUI display of a multiple choice quiz template according to a non-limiting embodiment;

FIGS. 22A-B illustrate example GUI displays of a multiple answer quiz template according to non-limiting embodiments;

FIG. 23A-B illustrate example GUI displays of an ordering quiz template according to non-limiting embodiments;

FIG. 24 illustrates an example GUI display of an essay quiz template according to a non-limiting embodiment;

FIG. 25 illustrates an example GUI display of a true/false quiz template according to a non-limiting embodiment; and

FIG. 26 illustrates an example GUI display of a CDMS display for authorized users according to a non-limiting embodiment.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure embodiments as they are oriented in the drawing figures. However, it is to be understood that embodiments may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible.

As used herein, the term “computing device” may refer to one or more electronic devices configured to process data, such as a processor (e.g., a CPU, a microcontroller, and/or any other data processor). A computing device may, in some examples, include the necessary components to receive, process, and output data, such as a display, a processor, a memory, an input device, and a network interface. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may also be a desktop computer or other form of non-mobile computer.

As used herein, the term “server” may refer to or include one or more computing devices that are operated by or facilitate communication and/or processing for multiple parties in a network environment, such as the Internet, although it will be appreciated that communication may be facilitated over one or more public or private network environments and that various other arrangements are possible. Further, multiple computing devices (e.g., servers, other computing devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

Non-limiting embodiments of a content development management system (CDMS) and method provide a multi-tenant architecture that allows for customization and separability between content and groups of users. Users can search content at any level, including metadata, in a quick and efficient manner, and are provided with tools to customize and personalize content for their own needs. In non-limiting embodiments, the multi-tenant architecture of the systems described herein allows for the activities of end-users to be logged to keep track of revisions and modifications and to allow users to undo changes. Non-limiting embodiments provide for enhanced and efficient data processing resulting from the multi-tenant architecture such that users may execute queries and other functions across a limited subset of data applicable to those users without underdoing additional and/or unnecessary processing. Those skilled in the art will appreciate other technological advantages and efficiencies achieved through non-limiting embodiments as described herein.

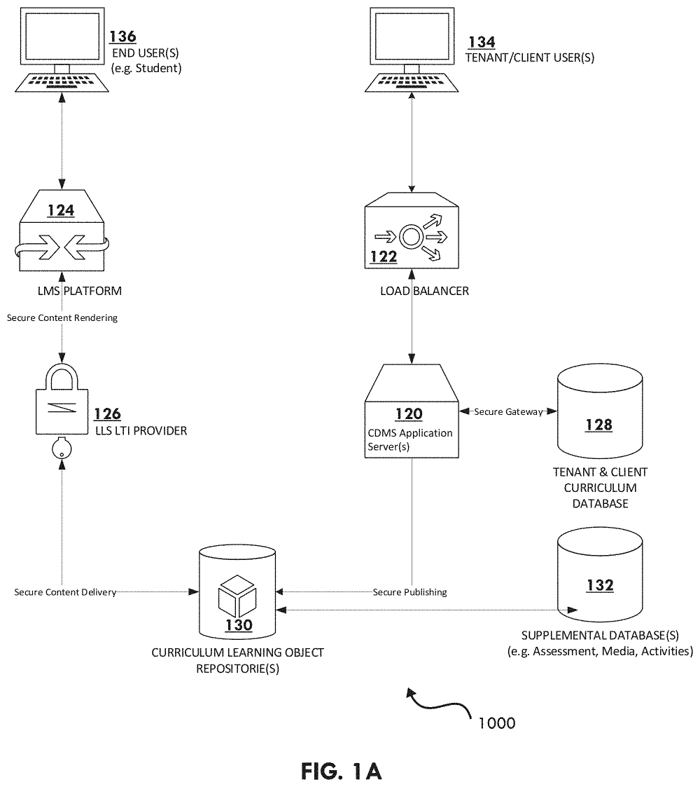

Referring now to FIG. 1A, a content development management system (CDMS) 1000 is shown according to a non-limiting embodiment. A CDMS Application Server 120 includes a computing device and is in communication with a global curriculum database (learning object repository) 130, a tenant/client curriculum database 128, and a plurality of tenant/client user computers 134 through a load balancer 122 to distribute the workloads of the plurality of user computers (tenant/client user(s)) 134 on the application server 120. The tenant/client curriculum database 128 includes modified content, new content, a history of modifications, and/or other like data unique to a particular entity (e.g., tenant or client) such that the modified content, new content, and other contents of the database 128 is unavailable to other entities. When the content from database 128 is published, it is communicated to the curriculum database 130 as one or more learning objects accessible only to authorized end-users associated with the tenant/client.

With continued reference to FIG. 1A, in non-limiting embodiments or aspects, a prior version of published content may be restored. An authorized user may select one of the prior modifications from the history of modifications stored in the tenant/client curriculum database 128. The authorized user may send a request to restore the prior modification of the content. The prior modification of the content may then be published on the curriculum database 130, replacing the previously published version of the content.

With continued reference to FIG. 1A, the curriculum database may be in communication with one or more supplemental databases 132. The supplemental databases 132 may include interactive assets such as media, quizzes, activities, video, assessments, and/or the like. Curriculum learning objects may be linked with interactive assets such that the interactive assets remain stored within the supplemental database 132 and are not stored in the tenant/client curriculum database 128. Modifications to the interactive assets may be automatically incorporated into the learning objects linking the interactive assets. More than one learning object may link to the same interactive asset.

With continued reference to FIG. 1A, in non-limiting embodiments or aspects, content stored in the tenant/client curriculum database 128 may be modified using a check-out/check-in function. In order to modify content, an authorized user may be required to first check-out the content (e.g., associate the content with the authorized user such that the content may be used). An authorized user may send a check-out request for the content. A check-out request may be sent by an authorized user when the authorized user attempts to edit the content. The check-out request may be granted automatically if the content is not already checked out. A check-out request may be automatically denied if the content is already checked out. In non-limiting embodiments or aspects, the check-out of the content may require authorization by an administrator before the check-out is granted. Once content is checked out, the content may become locked, allowing only the authorized user that checked out the content to make edits to the content. Other authorized users may not be able to make edits to the content, unless they have permissions to override checked-out items. In non-limiting embodiments, if other authorized users attempt to check-out or edit checked-out content, they may be notified of the identity of the user who has currently checked out the content. In some non-limiting embodiments, a user may be able to preview checked-out content. In some non-limiting embodiments, checked-out content may be checked in (e.g., disassociated with the authorized user) automatically after a predetermined time, e.g., 24 hours. If content is automatically checked in, unsaved changes to the content may be discarded. The authorized user that checked out the content may check in the content. Content may be checked in by an authorized user submitting a check-in request. Once content is checked in, the version of the content that was checked in may be stored in the tenant/client curriculum database 128. The checked-in content may be stored as a separate entry from the checked-out content. After content is checked in, all authorized users to the content will be allowed access to the content.

With continued reference to FIG. 1A, a Learning Management System (LMS) platform 124 may include a computing device and/or a server-side software application or a client-side software application that is accessible by a plurality of end-user computers 136. The LMS platform 124 may be in communication with a Learning Tools Interoperability (LTI) provider system 126, which may be a computing device and/or software application in communication with the curriculum database. In this manner, end-user computers 136 may access the curriculum content in a manner specified by the tenant/client associated with such end-user computers 136.

Referring now to FIG. 1B, a content development management system 1000 is shown according to another non-limiting embodiment. The system 1000 includes a server computer 100 in communication with a curriculum database 110 and a modification database 112. Although the databases 110, 112 are shown in FIG. 1B as separate databases, it will be appreciated that one or more data structures of various types may be utilized to store curricula content and modifications to such curricula content. The curriculum database 110 stores curricula content, such as lessons, quizzes, activities, templates, and/or the like. The modification database 112 stores and tracks modifications made to curricula content from the curriculum database 110. For example, modifications (e.g., changes, updates, edits, etc.) may be entirely stored in the modification database 112 or, in other examples, modified content may be stored in the curriculum database 110 and a history of such modifications (e.g., user identifier, date/time, type of modification, etc.) may be stored in the modification database 112 in relation to such modified content. It will be appreciated that various arrangements are possible.

With continued reference to FIG. 1B, a first entity 114 and a second entity 116 are in communication with the server computer 100 through a network environment, such as the Internet and/or a private network. The first entity 114 includes a plurality of user computers 104a, 104b displaying a GUI 102. The GUI 102 is based on the identification of the first entity and includes curricula content and/or modified curricula content associated with the first entity 114. The second entity 116 also includes a plurality of user computers 108a, 108b displaying a GUI 106. The GUI 106 displayed on the computers of the second entity 116 is based on the identification of the second entity 116 and includes curricula content and/or modified curricula content associated with the second entity 116. It will be appreciated that embodiments of the system 1000 may be implemented with any number of entities and/or computing devices.

In non-limiting embodiments, the CDMS application server 120 may be hosted by a third party. The CDMS application server 120, in some examples, may utilize cloud geo-located architecture. In some examples, access to the CDMS application server 120 may be controlled through authorize and authenticate integration such as Security Assertion Markup Language (SAML) authentication and/or the like.

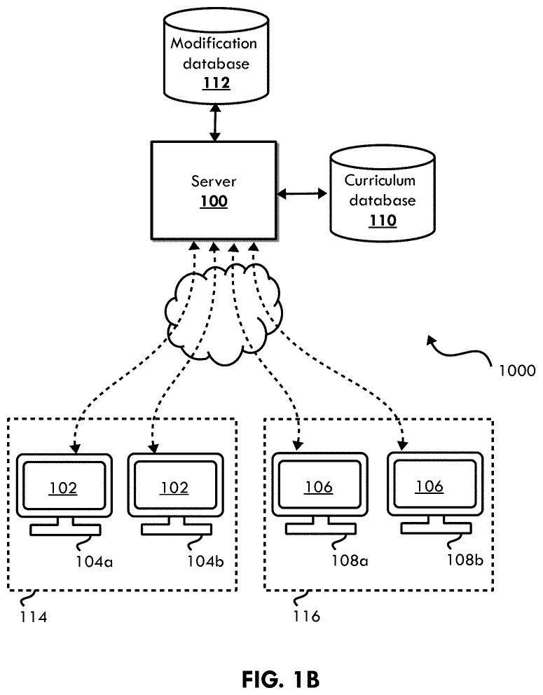

Referring now to FIG. 2, shown is a diagram of example components of a device 900 according to non-limiting embodiments. Device 900 may correspond to the server 100, first entity computers 104a, 104b, second entity computers 108a, 108b, curriculum database 110, and/or modification database 112 shown in FIG. 1B, as examples. In some non-limiting embodiments, such systems or devices may include at least one device 900 and/or at least one component of device 900. The number and arrangement of components shown in FIG. 2 are provided as an example. In some non-limiting embodiments, device 900 may include additional components, fewer components, different components, or differently arranged components than those shown in FIG. 2. Additionally, or alternatively, a set of components (e.g., one or more components) of device 900 may perform one or more functions described as being performed by another set of components of device 900.

As shown in FIG. 2, device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 2, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

In non-limiting embodiments or aspects, curriculum learning objects may be created, edited, and/or saved using editing software, such as a What You See Is What You Get (WYSIWYG) editor. The editing software may be used through a web browser, through a mobile application, and/or the like. The editing software may include a word processor, a spell checker, a language translator, an image insertor/manipulator, a readability analyzer (e.g., a Flesch-Kincaid Readability score checker), an external link embedder, a math equation creator, chemistry formula creator, iFrame embedder, and/or the like. A curriculum learning object may be checked out for editing, preventing other users from modifying the curriculum learning object while it is checked out. Track changes and commenting may be utilized during editing. Other users may then modify the curriculum learning object after it has been checked in. Curriculum learning objects may be able to be cloned and/or deleted. When a curriculum learning object is deleted, it may be soft deleted such that it is transferred to a recycle bin. Curriculum learning objects may be permanently deleted from the recycle bin, or may be restored or copied from the recycle bin. Restoring a learning object from the recycle bin may return the learning object to become an active object.

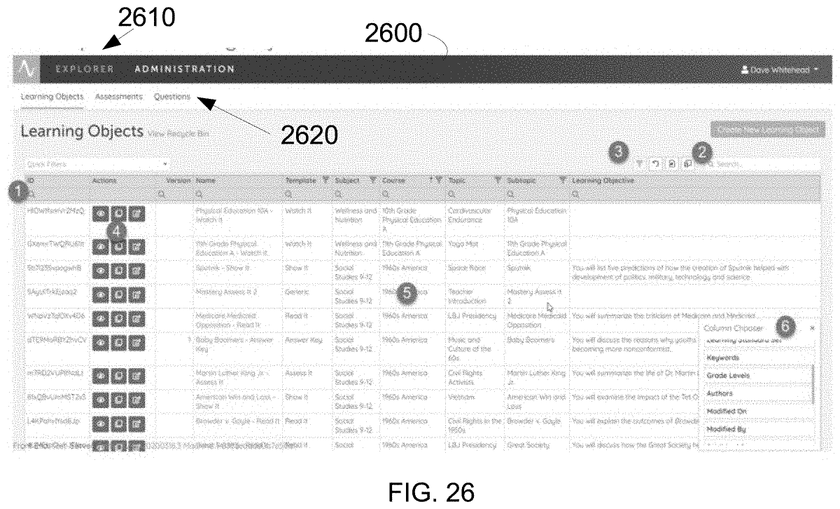

In non-limiting embodiments or aspects, in reference to FIG. 26, a display 2600 on the GUI 102 for the CMDS may include at least one tab 2610 for authorized users. The tabs 2610 may include a dashboard, content and assessments explorer, administration, library, and/or the like. Each tab 2610 may include one or more sub-tabs 2620. Each tab 2610 and/or sub-tab 2620 may be displayed adjacent to the previous tab 2610 and/or sub-tab 2620. Tabs 2610 and/or sub-tabs 2620 may also be displayed using a drop-down menu.

In non-limiting embodiments or aspects, the dashboard tab may display a dashboard GUI including recent activity of the entity, currently checked-out items, progress on publishing, notifications, and/or the like. Notifications may be displayed to notify the authorized user of the health of the applications, for example, updates to the application, potential upcoming outages of the application, and/or the like. Notifications may also notify authorized users of issues with publishing learning objects, for example, successful publishing of a learning object, failure of a learning object to publish, removal of a learning object, and/or the like. The creation of a new learning object may be initiated through the dashboard GUI.

In non-limiting embodiments, the content and assessments explorer tab may present an explorer GUI configured to facilitate an entity to search for learning objects, assessments, and/or questions. The learning objects, assessments, and/or questions may each be displayed on their own respective sub-tabs. The search may allow for a filtered search based on at least one parameter, including searching all metadata for the searched terms. The search may utilize an elastic search engine. The elastic search engine may allow for real-time results such that the search results appear as the search is being typed. Search parameters may include, for example, identification number, version, name, author, date of modification, keyword, subtopic, template, subject, course, topic, learning objective, learning standards, publishing status, grade level, and/or the like. Search results may display the parameters of each result, with each parameter being displayed in a separate column. In some examples, the authorized user may select which parameters are displayed in the search results.

In non-limiting embodiments or aspects, the authorized user may edit or create new learning objects, assessments, and/or questions through the respective sub-tabs of the explorer tab and/or through GUIs otherwise made available to the user. Editing an assessment may allow an authorized user to edit the text, metadata, settings, resources, and/or the like of the assessment. Editing a learning objective may allow an authorized user to edit the text and images of the learning object, insert and edit activities and quizzes, edit metadata, view history of a previous version, and/or the like.

In non-limiting embodiments, the administration tab may include at least one sub-tab or other selectable options for presenting further GUIs. The sub-tabs may be based on the metadata of the curriculum learning objects and may include subjects, courses, topics, subtopics, keywords, authors, learning standards, learning standard sets, development year, and/or the like. The sub-tabs may group curriculum learning objects based on the metadata category of the sub-tab.

In non-limiting embodiments, the library tab may include at least one sub-tab or other selectable options of tools for editing the user interface. The sub-tabs may include alerts, buttons, cards, panels, general user interface elements, and/or the like.

In non-limiting embodiments or aspects, the GUIs 106 may display at least one of a plurality of activity templates. The activity templates may be stored in the curriculum database 110 and/or the supplemental database 132. The activity templates may include an align template, a chart template, a crossword template, a “Did You Know” template, a drag and drop template, a flashcard template, a hotspot template, an identify template, a jigsaw template, a labeling template, an ordering template, a pairs template, a photo album template, a selection template, a sequence template, a slideshow template, a sorting template, a tabs template, a timeline template, a word search template, a quiz template, and/or the like. The entity may be able to edit the text of the activity templates. The activities may be accessed and completed by end-users through end-user computers 136.

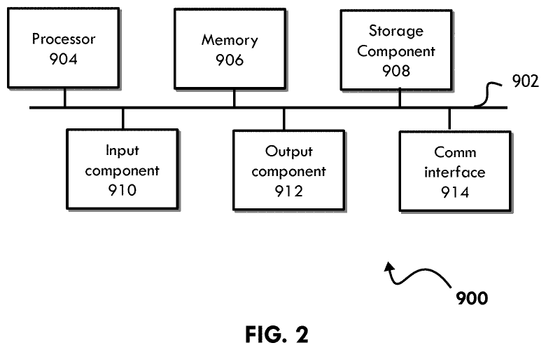

In non-limiting embodiments or aspects, an align template 300 may enable end-users to group similar objects or items into categories, for example, by providing end-users with a list of objects or items 310 and allowing the end-user to move each item either to a first column or to a second column (see FIG. 3). Items or objects may be moved by the end-user by, for example, dragging the item or object from one location to the other, or clicking on a directional arrow 320 to move the item or object in the selected direction.

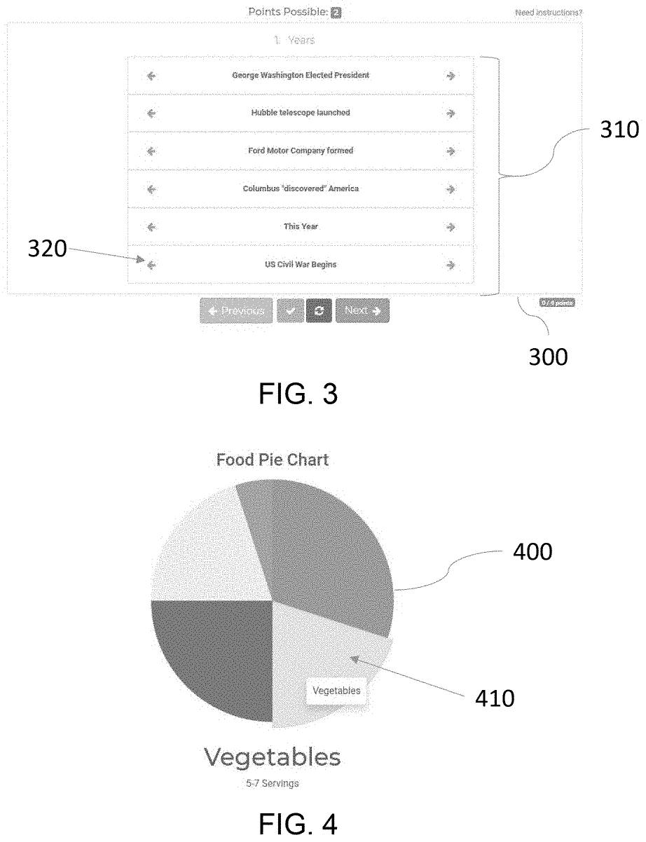

In non-limiting embodiments or aspects, a chart template 400 may provide end-users with information in the form of graphics, such as, for example, a pie chart (see FIG. 4), a pyramid chart, and/or the like. The end-user may view sets and subsets of information 410 in the chart by interacting with the chart, for example, by clicking on or interacting with a portion of the chart with a cursor or touchscreen.

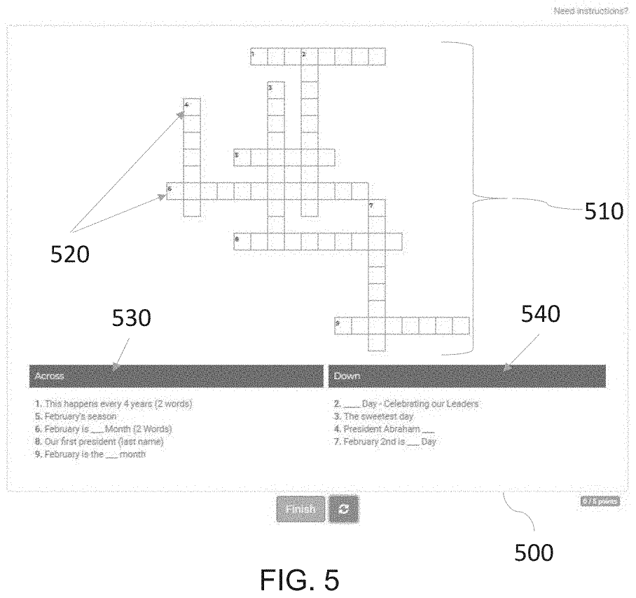

In non-limiting embodiments or aspects, a crossword activity template 500 may enable end-users to enter words and/or numbers into a set of boxes 510 arranged in overlapping horizontal and vertical arrangements 520. The number of boxes in each vertical or horizontal arrangement may equal the number of letters of the answer for the corresponding clue. The clues may be displayed in the bottom of the GUI 106, separated into two columns: (1) clues for horizontal entries (across) 530 and (2) clues for vertical entries (down) 540 (see FIG. 5). The set of boxes may be displayed above the clues. Each clue may be numbered. The corresponding clue number may be listed in the first box of the set of boxes corresponding to the clue.

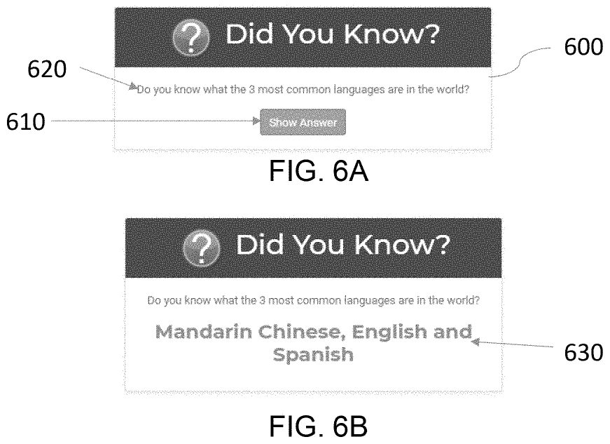

In non-limiting embodiments or aspects, a “Did You Know” template 600 may display a question or statement 620 (see FIG. 6A). An end-user may reveal an answer to the question or additional details about a statement 630 (see FIG. 6B) by interacting with the activity, for example, by clicking on a button 610 with a cursor.

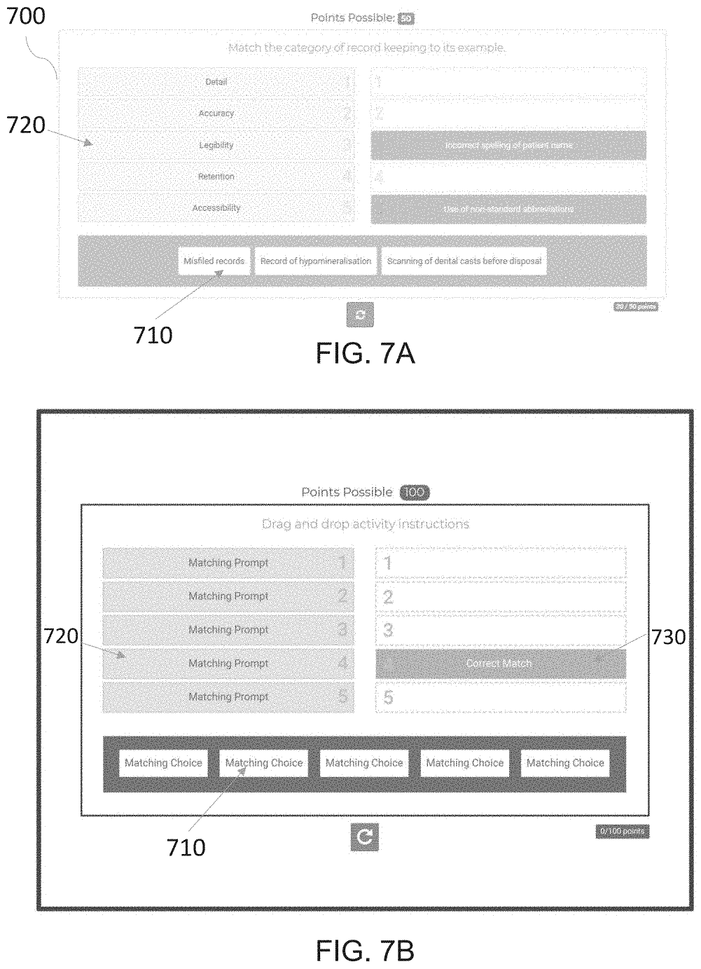

In non-limiting embodiments or aspects, a drag and drop template 700 may display at least one matching choice card 710 in a word bank and at least two matching prompts 720 in a set. The word bank may be displayed on the bottom of the GUI 106, while the set may be displayed in a column (see FIG. 7A). The end-user may drag the matching choice card 710 in the word bank and place it next to the corresponding matching prompt 720 in the set to complete the activity (see FIG. 7B). A correct placement of a matching choice may result in a notification 730 that the placement was correct, such as displaying “correct choice” in the location of the placement.

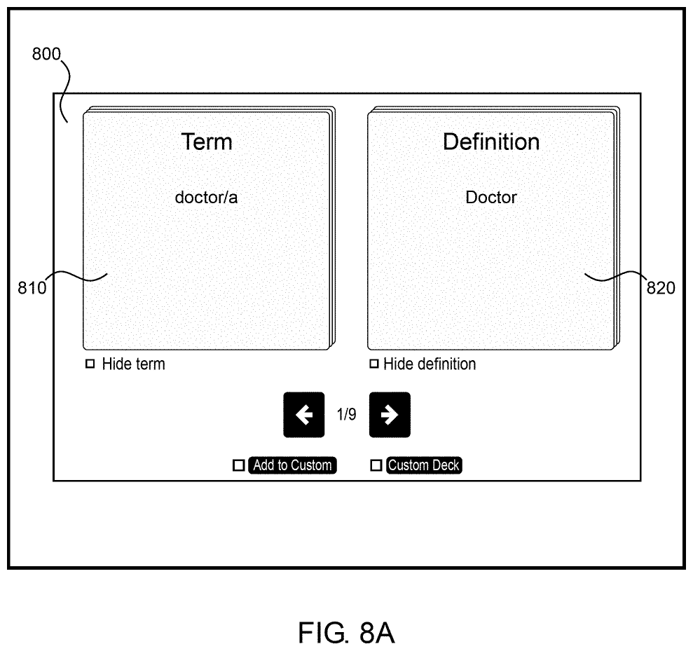

In non-limiting embodiments or aspects, a flashcard template 800 may display information on individual cards. The flashcards may provide a section for a term 810 and a section for its definition 820. The flashcards may also display images, math equations, and/or chemistry equations. The GUI 106 may display cards for both the term 810 and the definition 820 at the same time and may allow the end-user to hide the term and/or the definition (see FIGS. 8A-B). For example, hiding the term 810 (see FIG. 8C) and/or definition 820 (see FIG. 8D) may be done by clicking on a checkbox or button. The end-user may be able to scroll between flashcards, for example, by clicking a left button and/or right button. The end-user may be able to add specific sets of term and definition flashcards to a custom deck, for example, by clicking on a checkbox or button.

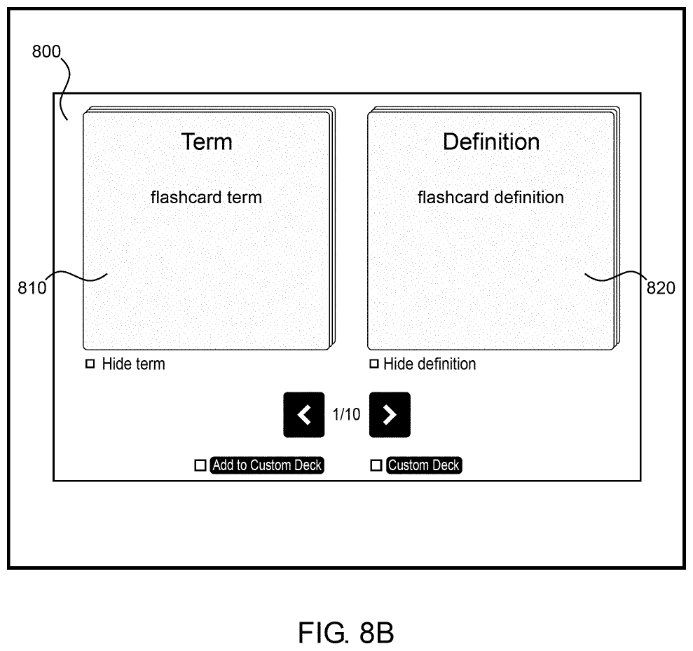

In non-limiting embodiments or aspects, a hotspot template 990 may display images, equations, and/or formulas. More information 992 on the images, equations, and/or formulas may be displayed in the GUI 106 by the end-user by interacting with the activity, for example, by hovering the cursor over or otherwise interacting with sections of the images, equations, and/or formulas (see FIG. 9). Hovering over or touching different sections of the display image, equation, and/or formula with the cursor or through a touchscreen may display different additional information.

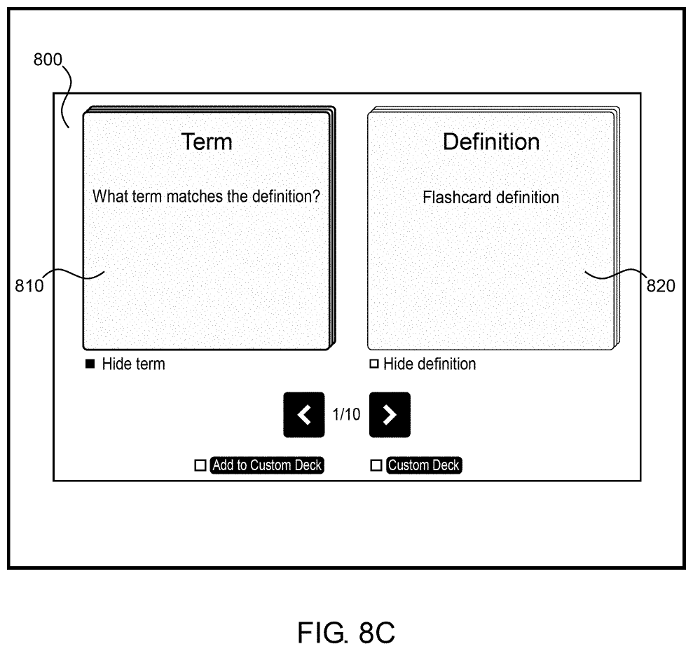

In non-limiting embodiments or aspects, an identify template 1090 may display information, such as text, images, equations, and/or formulas, on at least two individual slides 1092. At least two terms and/or phrases 1094 are also provided corresponding to the display information. The end-user may match the term or phrase with the displayed slide to complete the activity (see FIG. 10A). An end-user may select a term or phrase by, for example, scrolling through the provided terms and/or phrases by clicking on arrows next to the displayed term and/or phrase to display the next term and/or phrase. Once the correct term and/or phrase is displayed, the end-user may check the answer by clicking on a button with the cursor (see FIGS. 10B-10C). The answer may also be checked by pressing a key on the keyboard.

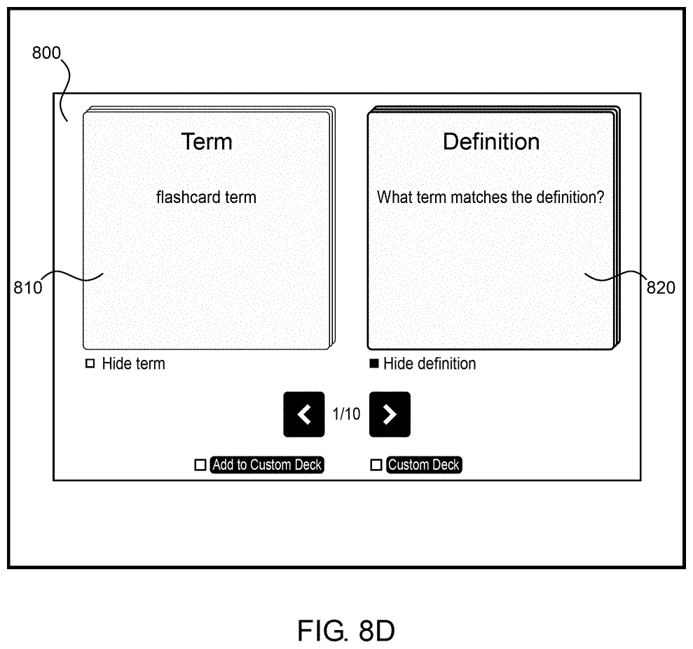

In non-limiting embodiments or aspects, a jigsaw activity 1100 may display an image that is broken into at least two sub-pieces 1110. The sub-pieces 1110 may be displayed in the GUI 106 out of order or in a pile with at least one sub-piece overlapping with at least one other sub-piece. The end-user may be able to place the sub-pieces in the correct order to display the full image. The end-user may place the sub-pieces by, for example, dragging each sub-piece and placing it in the proper relative location in a display window 1120 displayed in the GUI 106 (see FIG. 11). The sub-pieces 1110 may be displayed in a sub-piece window 1130 before being moved by the end-user. The display window 1120 may be sized to be the same size and/or shape as the full-assembled image. The display window 1120 may be a rectangle or other shape.

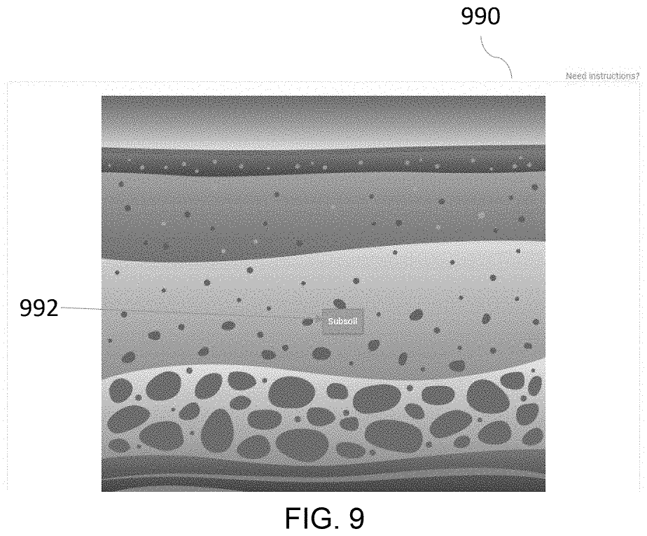

In non-limiting embodiments or aspects, a labeling activity 1200 may display an image 1220, equations, and/or formulas, and a word bank 1210 with at least one word (see FIG. 12). An end-user may move words from the word bank 1210 onto the image 1220, equations, and/or formulas such that the words are placed in a location 1230 that labels the location with the word. The words may be moved by an authorized user by clicking on the word and dragging the word to the location 1230 on the image, equation, and/or formula.

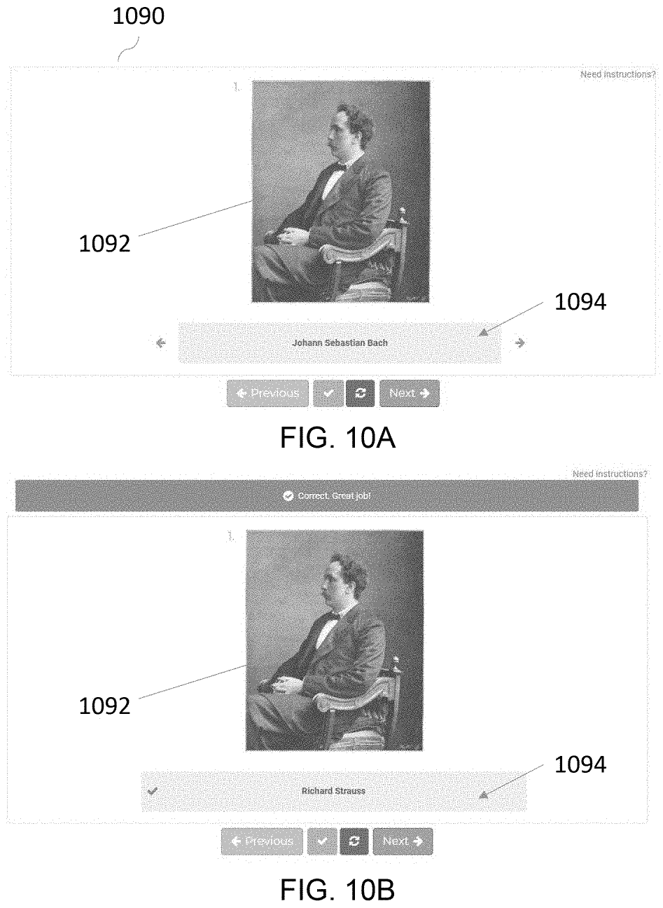

In non-limiting embodiments or aspects, an ordering activity 1300 displays a set of words and/or phrases 1310, such as items, steps, or terms. The set of words and/or phrases 1310 may be listed in a column (see FIG. 13). An end-user may move the set of words and/or phrases one at a time to a second location 1320, placing the words and/or phrases into an order, such as in a succession. As an example, the ordering activity 1300 may be used to place items in alphabetical order, grammatical order (e.g., sentence construction), and/or the like.

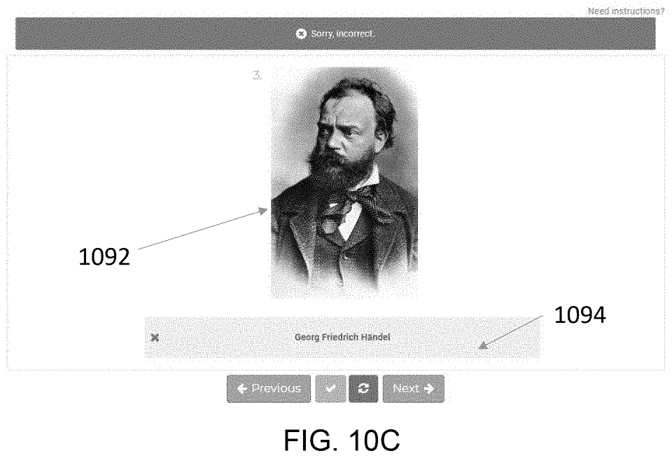

In non-limiting embodiments or aspects, a pairs activity 1400 may display a title 1410 and at least two items 1420, such as terms, topics, categories, ideas, and/or the like. An end-user may select matching pairs based on the title 1410 by, for example, selecting the first item, and then selecting the second item (see FIG. 14). An item 1420 may also be deselected. In non-limiting embodiments, a first item may be associated with at least one second item such that pairs or groups of items may be identified. For example, a user may match and pair a first item with multiple second items to create an associated grouping.

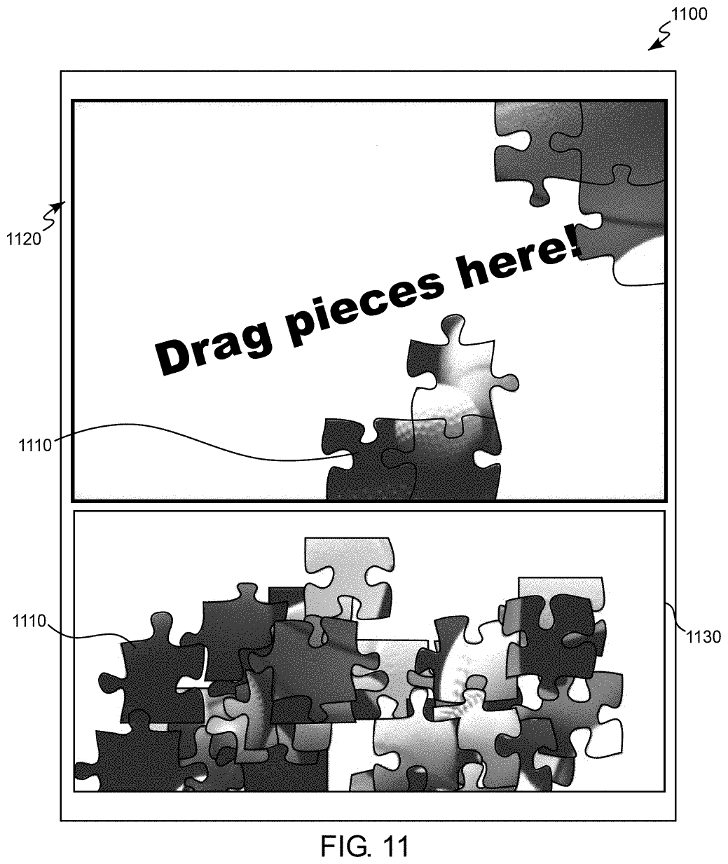

In non-limiting embodiments or aspects, a photo album activity 1500 may display one of at least two pages. Each page may include an image 1510, a math equation, a chemistry formula, and/or the like. Each page may also include a caption 1520 (see FIG. 15). An end-user may change pages by clicking on a button 1530 with the cursor or through a touchscreen to move to the next or previous page, may press a key on the keyboard, and/or the like.

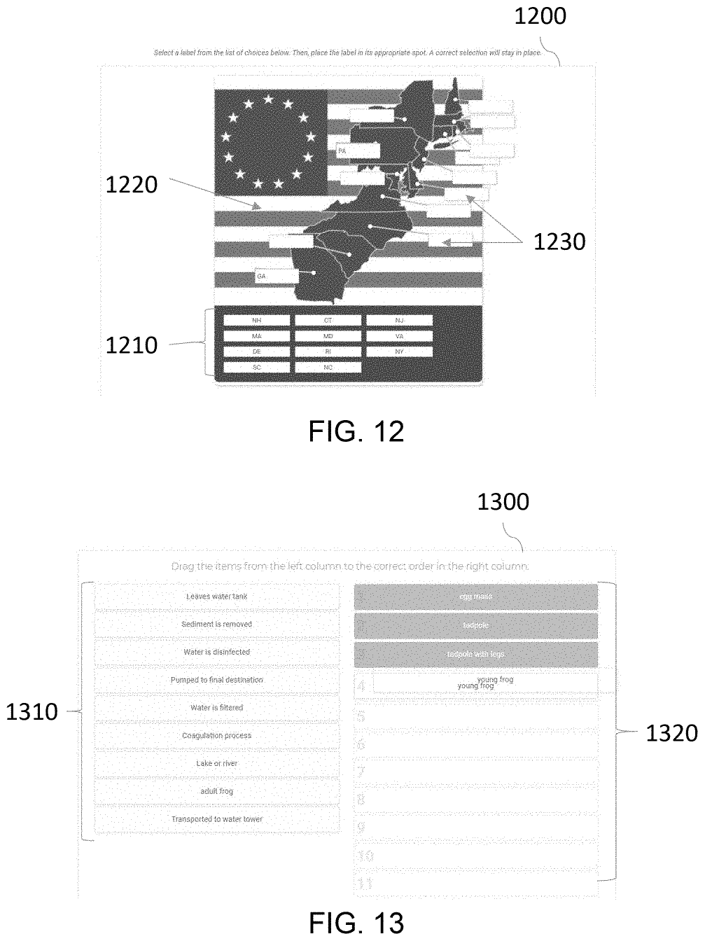

In non-limiting embodiments or aspects, a selection activity 1600 may display a set, group, or topic 1610 with at least two objects, words, concepts, and/or the like 1620 (see FIG. 16A). An end-user may select the objects, words, concepts, and/or the like that correspond to the set, group, or topic by, for example, clicking with the cursor or interacting with the activity 1600 through a touchscreen (see FIGS. 16B-C). After a selection is made, correct selections may cause the selection to change to a different color, for example green, may cause an icon to be displayed, and/or the like. An incorrect selection may cause the selection to change to a second different color, for example red, and/or cause an icon or notification to appear. The hatch patterns in FIGS. 16A-16C represent different colors/shading.

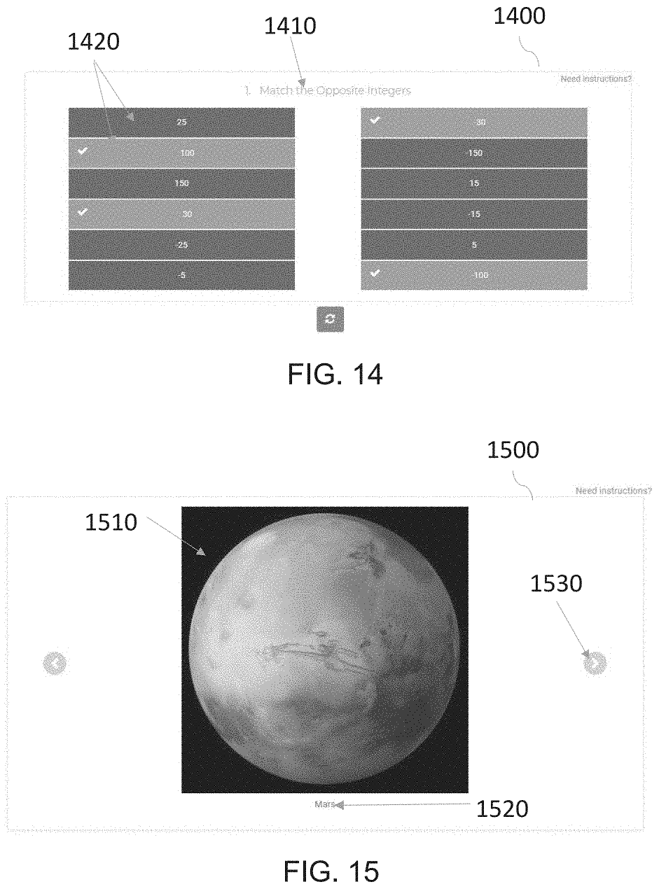

In non-limiting embodiments or aspects, a sequence activity 1700 may display at least two items 1710, such as events, steps of a process, a hierarchy, and/or the like. The items 1710 may be displayed in at least one column and/or row (see FIGS. 17A-B). An end-user may rearrange the items 1710 to put them in chronological order by, for example, clicking a button 1720 associated with an item with the cursor to move the item in the chronological order, clicking on an item with the cursor, and dragging the item in the chronological order. The end-user may be able to check on the correctness of the current placement of the events by, for example, pressing a check button 1730 (see FIG. 17C). The sequence activity 1700 may, for example, have a user place historical events in a temporal order, place process steps (e.g., such as a recipe) in a logical order, and/or the like.

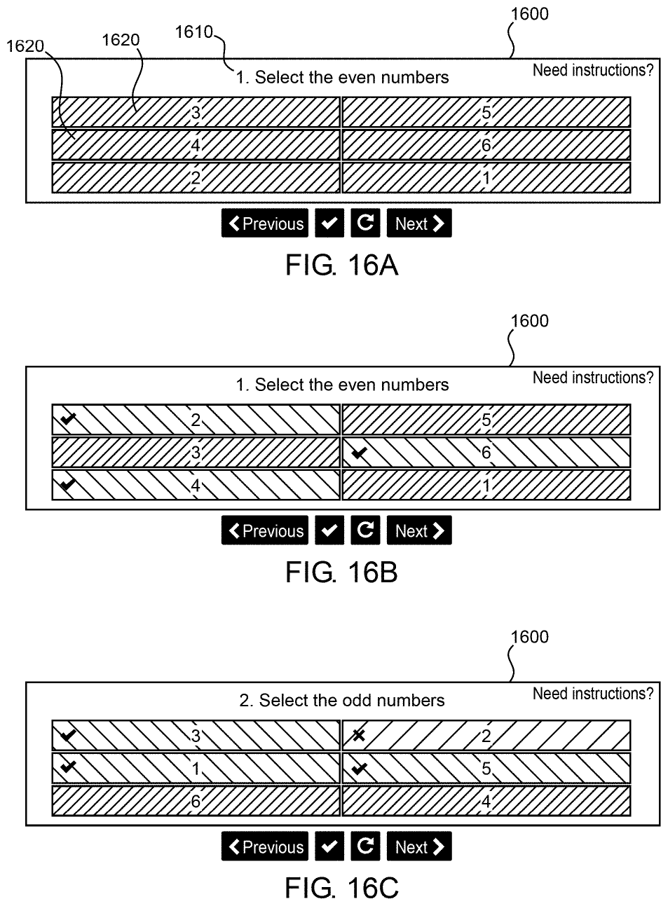

In non-limiting embodiments or aspects, a slideshow activity 1800 may contain at least two slides. One slide may be displayed at a time. Each slide may contain images 1810, text, and/or audio 1820 (see FIG. 18). The next slide of the slide show may display automatically after a predesignated period of time has elapsed. An end-user may change the display from one slide to a second slide by clicking on a button 1830 to display the next and/or previous slide.

In non-limiting embodiments or aspects, the sorting activity may display at least two cards. Each card may include text, an image, a math equation, a chemistry formula, and/or a combination thereof. At least two category headings may be displayed. The end-user may complete the activity by placing each card in the correct category. An end-user may place a card in a category by clicking a card with the cursor and dragging the card to the category heading. It will be appreciated that the number of categories may vary and that categories may include subcategories into which the cards are sorted.

In non-limiting embodiments or aspects, the tabs activity may display at least two tabs that may be selected by an end-user. Each tab may display information. When an end-user selects a tab, the tab's content information may be displayed, such as text, an image, math equation, and/or chemistry formula. An end-user may select a tab by clicking the tab with the cursor or selecting the tab through a touchscreen. The end-user may be able to scroll through tabs by clicking a button with the cursor, using a gesture on the touchscreen, or key on the keyboard to display the next and/or previous tab.

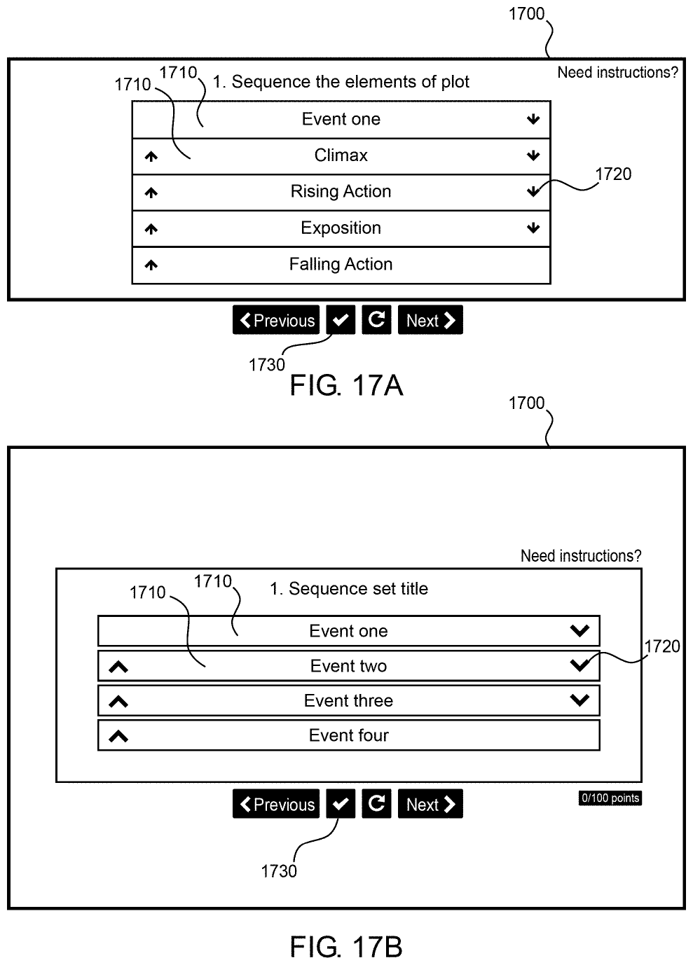

In non-limiting embodiments or aspects, a timeline activity 1900 may display a detailed view 1910 and a timeline view 1920. The timeline view 1920 may show a range of dates 1930 with at least two events labeled at their respective dates in the range. The detailed view 1910 may show information of an event, such as an image and/or text (see FIG. 19). An end-user may change the detailed view 1910 to a different event by pressing a button 1940 to display the next and/or previous event in chronological order. An end-user may also select an event by clicking on the event in the timeline view.

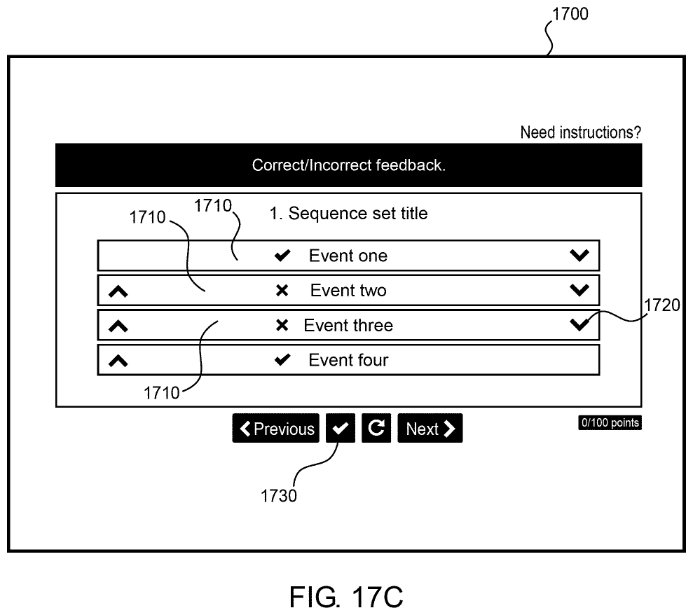

In non-limiting embodiments or aspects, a word search activity 2000 includes at least one term in a word bank 2010 and a word search window 2020. The word search window 2020 may include a grid of at least four letters in at least two rows and at least two columns. Each word in the word bank 2010 may be located within the word search window 2020, displayed in either a horizontal, vertical, or diagonal orientation. The end-user may complete the activity by highlighting each word of the word bank 2010 in the word search window 2020 (see FIG. 20). The end-user may highlight a word in the word search window 2020 by clicking the first letter of the word with the cursor and dragging the cursor to the last letter of the word. Once a word is highlighted in the word search window 2020, the word in the word bank 2010 may be crossed off.

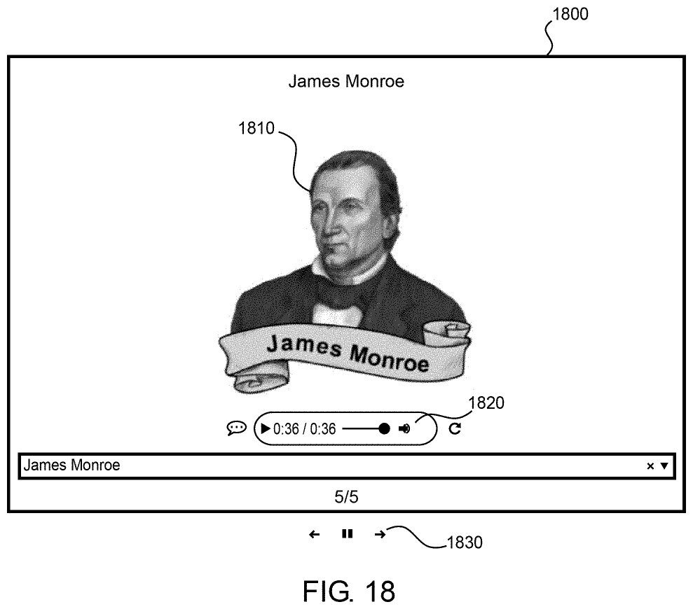

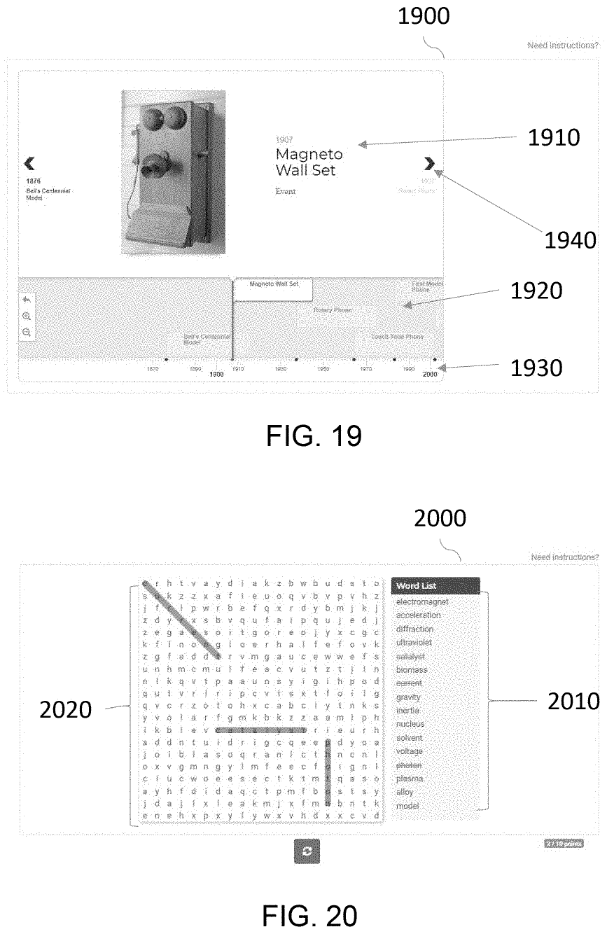

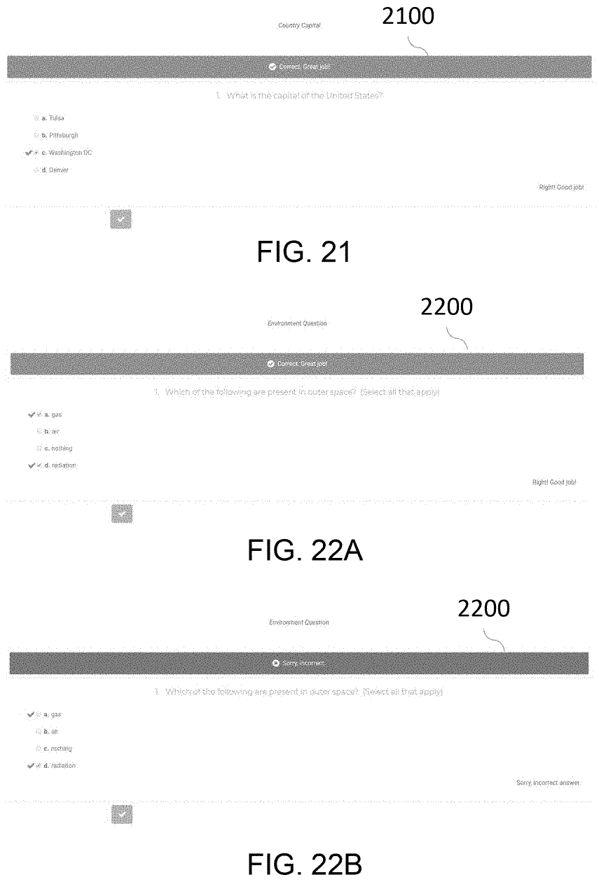

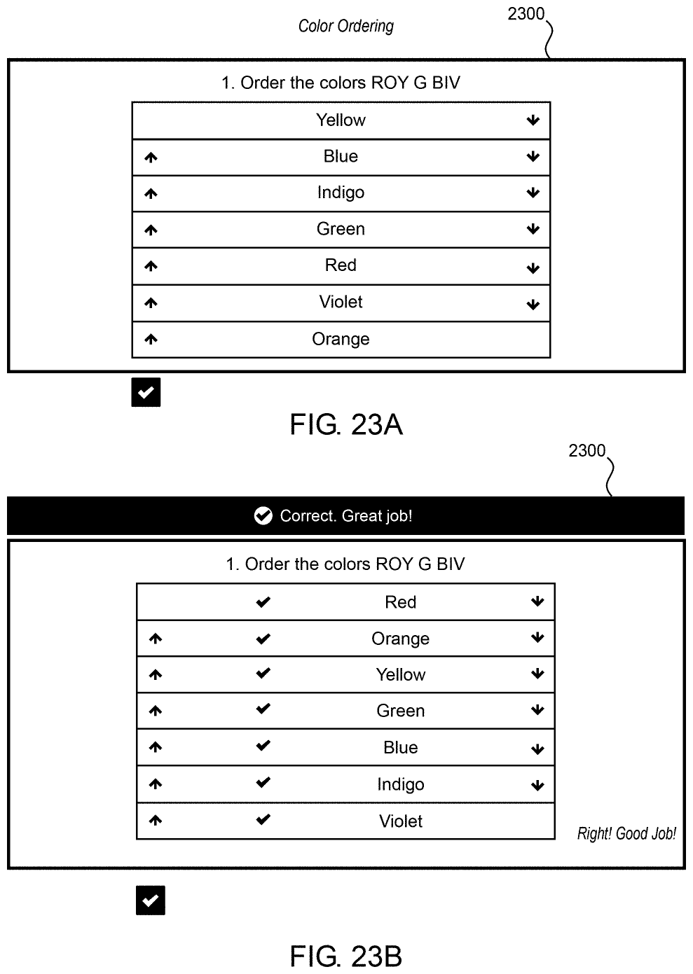

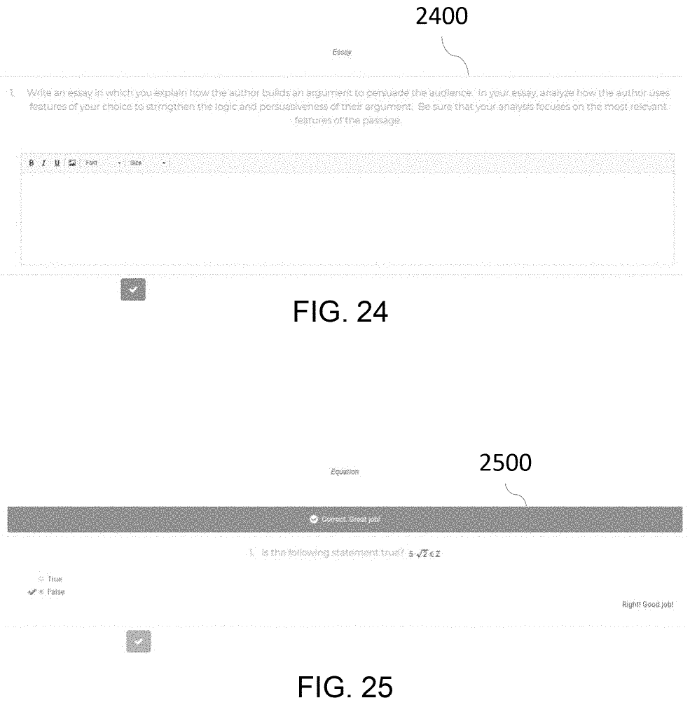

In non-limiting embodiments or aspects, the quiz activity may display one or more questions in the GUI 106. The questions may be essay questions 2400 (see FIG. 24), multiple answer questions 2200 (see FIGS. 22A-B), multiple choice questions 2100 (see FIG. 21), fill in the blank questions, matching questions, ordering questions 2300 (see FIGS. 23A-B), and/or true/false questions 2500 (see FIG. 25). Answers to the questions may include text, images, equations, and/or formulas. When displayed to the end-user, answers may be displayed in a random order. The end-user may answer one question at a time. The next question may be displayed after the end-user enters an answer to the previous question. An end-user may also scroll through questions by clicking on a button to move to the next and/or previous question.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A content development management system, comprising at least one server computer in communication with a plurality of user computers over a network environment, the at least one server computer including at least one processor programmed or configured to:
distribute a content development platform to a plurality of different entities, each entity of the plurality of entities comprising a plurality of users;
receive, from a first user associated with a first entity of the plurality of entities, a first modification to first content;
store the first modification to the first content in a database in association with the first entity, such that other entities of the plurality of entities cannot access the first modification; and
allow access to the first modification to the first content from authorized users of the first entity.

2. The content development management system of claim 1, wherein the content development platform comprises a plurality of activity templates.

3. The content development management system of claim 1, wherein the at least one processor is further programmed or configured to:
receive, from the first user, a publication request associated with the first modification to the first content;
queue the publication request in a publication queue; and
in response to an input from an administrative user, publish the first modification to the first content such that the authorized users of the first entity are allowed access.

4. The content development management system of claim 1, wherein the at least one processor is further programmed or configured to:
in response to receiving a check-out request from the first user for the first content, lock the first content, allowing only the first user of the plurality of users to modify the first content; and
in response to receiving a check-in request from the first user for the first content, store the first content in a database in association with the first content and allow access to the first content from authorized users of the first entity.

5. The content development management system of claim 1, wherein the at least one processor is further programmed or configured to:
receive, from the first user associated with the first entity of the plurality of entities, a second modification to the first content;
store the second modification to the first content in a database in association with the first entity; and
receive, from the first user associated with the first entity of the plurality of entities, a request to restore the first modification to the first content, replacing the second modification to the first content with the first modification to the first content.

6. The content development management system of claim 1, wherein the at least one processor is further programmed or configured to:
store an interactive asset in a database in association with the first entity;
link the interactive asset to the first content; and
display the interactive asset in the first content when accessed by an end-user.

7. The content development management system of claim 6, wherein the at least one processor is further programmed or configured to:
link the interactive asset to a second content;
receive a modification to the interactive asset; and
display the modification to the interactive asset in both the first content and the second content when accessed by an end-user.

8. A computer-implemented method of content development management, comprising:
distributing, with at least one processor, a content development platform to a plurality of different entities, each entity of the plurality of entities comprising a plurality of users;
receiving, from a first user associated with a first entity of the plurality of entities, a first modification to first content;
storing, with the at least one processor, the first modification to the first content in a database in association with the first entity, such that other entities of the plurality of entities cannot access the first modification; and
allowing, with the at least one processor, access to the first modification to the first content from authorized users of the first entity.

9. The computer-implemented method of claim 8, wherein the content development platform comprises a plurality of activity templates.

10. The computer-implemented method of claim 8, further comprising:
receiving, from the first user, a publication request associated with the first modification to the first content;
queuing, with the at least one processor, the publication request in a publication queue; and
in response to an input from an administrative user, publishing, with the at least one processor, the first modification to the first content such that the authorized users of the first entity are allowed access.

11. The computer-implemented method of claim 8, further comprising:
in response to receiving a check-out request from the first user for the first content, locking the first content, allowing only the first user of the plurality of users to modify the first content; and
in response to receiving a check-in request from the first user for the first content, storing the first content in a database in association with the first content and allowing access to the first content from authorized users of the first entity.

12. The computer-implemented method of claim 8, further comprising:
receiving, from the first user associated with the first entity of the plurality of entities, a second modification to the first content;
storing the second modification to the first content in a database in association with the first entity; and
receiving, from the first user associated with the first entity of the plurality of entities, a request to restore the first modification to the first content, replacing the second modification to the first content with the first modification to the first content.

13. The computer-implemented method of claim 8, further comprising:
storing, with the at least one processor, an interactive asset in a database in association with the first entity;
linking, with the at least one processor, the interactive asset to the first content; and
displaying, with the at least one processor, the interactive asset in the first content when accessed by an end-user.

14. The computer-implemented method of claim 13, further comprising:
linking, with the at least one processor, the interactive asset to a second content;
receiving, with the at least one processor, a modification to the interactive asset; and
displaying, with the at least one processor, the modification to the interactive asset in both the first content and the second content when accessed by an end-user.

15. A computer program product of content development management, comprising at least one non-transitory computer-readable medium including program instructions that, when executed by at least one processor, cause the at least one processor to:
distribute a content development platform to a plurality of different entities, each entity of the plurality of entities comprising a plurality of users;
receive, from a first user associated with a first entity of the plurality of entities, a first modification to first content;
store the first modification to the first content in a database in association with the first entity, such that other entities of the plurality of entities cannot access the first modification; and
allow access to the first modification to the first content from authorized users of the first entity.

16. The computer program product of claim 15, wherein the content development platform comprises a plurality of activity templates.

17. The computer program product of claim 15, wherein the program instructions further cause the at least one processor to:
receive, from the first user, a publication request associated with the first modification to the first content;
queue the publication request in a publication queue; and
in response to an input from an administrative user, publish the first modification to the first content such that the authorized users of the first entity are allowed access.

18. The computer program product of claim 15, wherein the program instructions further cause the at least one processor to:
in response to receiving a check-out request from the first user for the first content, lock the first content, allowing only the first user of the plurality of users to modify the first content; and
in response to receiving a check-in request from the first user for the first content, store the first content in a database in association with the first content and allow access to the first content from authorized users of the first entity.

19. The computer program product of claim 15, wherein the program instructions further cause the at least one processor to:
receive, from the first user associated with the first entity of the plurality of entities, a second modification to the first content;
store the second modification to the first content in a database in association with the first entity; and
receive, from the first user associated with the first entity of the plurality of entities, a request to restore the first modification to the first content, replacing the second modification to the first content with the first modification to the first content.

20. The computer program product of claim 15, wherein the program instructions further cause the at least one processor to:
store an interactive asset in a database in association with the first entity;
link the interactive asset to the first content;
display the interactive asset in the first content when accessed by an end-user;
link the interactive asset to a second content;
receive a modification to the interactive asset; and
display the modification to the interactive asset in both the first content and the second content when accessed by an end-user.
